(19) United States
(12) Patent Application Publication
(10) Pub. No.: US 2025/0224244 A1
(43) Pub. Date: Jul. 10, 2025

(54) PATH PLANNING METHOD, ELECTRONIC DEVICE, AND NON-TRANSITORY STORAGE MEDIUM

(71) Applicant: HON HAI PRECISION INDUSTRY CO., LTD., New Taipei (TW)

(72) Inventors: YU-KAI ZHOU, New Taipei (TW); CHIN-PIN KUO, New Taipei (TW)

(21) Appl. No.: 18/639,472

(22) Filed: Apr. 18, 2024

(30) Foreign Application Priority Data
Jan. 9, 2024 (CN) 202410032959.7

(51) Int. Cl. G01C 21/34; G01C 21/36; G08G 1/01; G08G 1/0968

(52) U.S. Cl. CPC G01C 21/3492; G01C 21/3602; G01C 21/3691; G08G 1/0112; G08G 1/096844

(57) ABSTRACT

A path planning method applied to a vehicle. The path planning method comprises obtaining a current location of the vehicle in real time, determining road data and traffic flow data matched with the current location of the vehicle, determining an objective vehicle according to the vehicle identify information, obtaining the vehicle location of the objective vehicle, and obtaining an objective driving location of the vehicle and determining a planned driving path of the vehicle based on the vehicle location of the objective vehicle, the current location, and the objective driving location of the vehicle. An electronic device and a non-transitory storage are also disclosed.

### FIELD

The subject matter herein generally relates to vehicle automatic driver field.

### BACKGROUND

With a development of automatic driver field, more and more special vehicles are appearing on the market, the special vehicle has special functions. The special vehicles may be autonomous vehicles, trucks, road clearing vehicles and so on.

While the technology development of the special vehicles is still being developed, items or goods carried by the special vehicles may be dangerous. Some special vehicles and consumer vehicles sharing the same traffic lanes, these special vehicles may cause road accidents and injuries to the consumer vehicles.

### BRIEF DESCRIPTION OF THE DRAWINGS

Implementations of the present disclosure will now be described, by way of embodiments, with reference to the attached figures.

FIG. 1 is a flowchart of an embodiment illustrating a path planning method according to the present disclosure.

FIG. 2 is a diagram illustrating an embodiment of environmental images according to of the present disclosure.

FIG. 3 is a diagram illustrating an embodiment of a path planning device according to the present disclosure.

FIG. 4 is a diagram of an embodiment of modules illustrating an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The connection can be such that the objects are permanently connected or releasably connected. The term “comprising,” when utilized, means “including, but not necessarily limited to;” it specifically indicates open-ended inclusion or membership in the so-described combination, group, series, and the like.

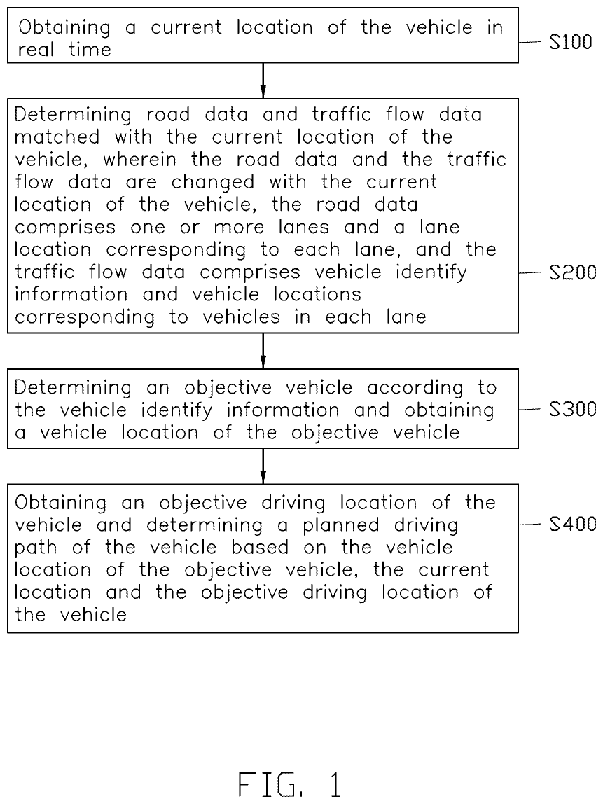

FIG. 1 illustrates one exemplary embodiment of a path planning method. The flowchart presents an exemplary embodiment of the method. The exemplary method is provided by way of example, as there are a variety of ways to carry out the method. Each block shown in FIG. 1 may represent one or more processes, methods, or subroutines, carried out in the example method. Furthermore, the illustrated order of blocks is illustrative only and the order of the blocks can change. Additional blocks can be added, or fewer blocks may be utilized, without departing from this disclosure.

The path planning method is used for a path planning system. The path planning system can be installed in a vehicle. For example, the vehicle can be a household vehicle, a commercial vehicle, or an engineering vehicle.

In block S100, a current location of the vehicle is obtained in real time.

The vehicle can be a vehicle equipped with the path planning system.

In one embodiment, the vehicle is installed a data collection device. The data collection device can be an in-vehicle sensor, a radar, a camera, or a global locating system (GPS) and so on. The in-vehicle sensor detects close-range obstacles around the vehicle, such as distance perception data when the vehicle is parking. The radar detects locations and speeds of surrounding objects by emitting radio waves and measuring the radio waves' reflections. The camera captures some videos to identify other vehicles, pedestrians, road signs and traffic signals. The GPS obtains real-time locating information of vehicles and plans driving paths for vehicles.

In the embodiment, the path planning system obtains the current location of the current based on the data collection device, the data collection device is installed in the vehicle.

In block S200, road data and traffic flow data matched with the current location of the vehicle are determined, the road data and the traffic flow data are changed with the current location of the vehicle, the road data includes one or more lanes and a lane location corresponding to each lane, and the traffic flow data includes vehicle identify information and vehicle locations corresponding to vehicles in each lane.

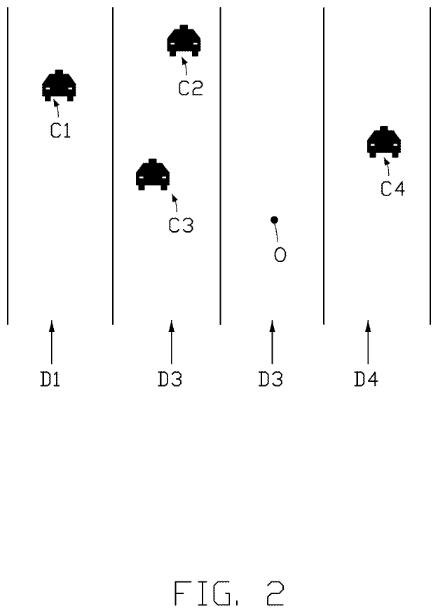

In one embodiment, the path planning system obtains the road data and the traffic flow data in a circle centered on the current location of the vehicle and radiused by a preset distance. Refer to FIG. 2, the current location of the vehicle is 0, the preset distance is 1 km. The path planning system obtains the road data and the traffic flow data in the circle centered on the current location O of the vehicle and radiused by 1 km. The road data includes an extension direction of each lane and a width of each lane. The traffic flow data includes the speed of each vehicle.

Further, the path planning system obtains environment images in the circle centered on the current location of the vehicle and radiused by the preset distance, the environment images include road images and traffic flow images based on a camera installed in the vehicle. For example, the road images are some first images showing road condition in the circle centered on the current location of the vehicle and radiused by the preset distance, the first images can be photos or videos. The traffic flow images are some second images showing driving conditions of vehicles in the circle centered on the current location of the vehicle and radiused by the preset distance. Then, the path planning system extracts the road data from the road images and extracts the traffic flow data from the traffic flow images. In the embodiment, the environment images are analyzed using image recognition technology, and are extracted to obtain the road images and the traffic flow images.

The image recognition technology extracts and classifies the road images and the traffic flow images by constructing deep neural network model, based on deep learning algorithm. Firstly, a large amount of image data is input into a neural network for training, the neural network can accurately recognize different categories of images by constantly adjusting the network parameters. Then, the image to be recognized is input into the trained neural network, and the network will output category labels of the image to realize the automatic recognition of the image.

In one embodiment, the path planning system also needs to clean original data obtained by the data collection device, the data collection device includes the road data and the traffic flow data. The path planning system converts the original data into analyzable data by cleaning, correcting, formatting and organizing the road data and the traffic flow data. For example, the original data can be cleaned by missing value processing, noise data clearing and consistency checking. Redundant data or useless data in the road data and the traffic flow data is eliminated. A format of the traffic flow data and the road data is converted to a unified format. In the embodiment, the road data includes one or more lanes and lane location of each lane, the traffic flow data includes the vehicle identify information and the vehicle location corresponding to vehicles in each lane.

Specifically, the vehicle identify information matching with the current location O of the vehicle is determined based on the traffic flow images, the vehicle identify information includes first license plate information. Objective license plate information matching with second license plate information is determined from the first license plate information, the vehicle corresponding to the second license plate information includes a first function, the first function illustrates the vehicle with an automatic driving function, a cargo function, or an engineering function. In other embodiments, the first function can also be a road clearing function, a traction function, an engineering function, and other functions. In the embodiment, a vehicle with the autonomous driving function is an autonomous vehicle, a vehicle with the cargo function is a truck, the truck can be a dump truck or a traction truck, a vehicle with the engineering function is an excavator, a bulldozer, a road roller, a loader, or an engineering rescue vehicle.

Refer to FIG. 2, the path planning system obtains the road data and the traffic flow data in the circle centered on the current location O of the vehicle and radiused by the preset distance. The road data extracted from the road images include a first lane D1, a second lane D2, a third lane D3, a fourth lane D4 and lane locations of four lanes. The traffic flow data extracted from the traffic flow images include first vehicle identity information of a first vehicle C1 on the first lane D1, second vehicle identity information of a second vehicle C2 on the second lane D2, third vehicle identity information of a third vehicle C3 on the second lane D2, fourth vehicle identity information of a fourth vehicle C4 on the fourth lane D4 and the vehicle location of four vehicles.

Further, the path planning system determines that a first license plate information of the first vehicle identity information corresponding to the first vehicle C1 is C11, determines that a first license plate information of the second vehicle identity information corresponding to the second vehicle C2 is C21, determines that a first license plate information of the third vehicle identity information corresponding to the third vehicle C3 is C31, and determines that a first license plate information of the fourth vehicle identity information corresponding to the fourth vehicle C4 is C41.

For example, in the embodiment, a database of the path planning system stores a second license plate information. The second license plate information includes C11, C41, C61, and C91. In order to facilitate understanding, the first function is token as the automatic driving function as an example. The vehicles with the second license plate information (C11, C41, C61 and C91) have automatic driving functions. The objective license plate information matching with the second license plate information (C11, C41, C61 and C91) is determined from the first license plate information (C11, C21, C31 and C41). The objective license plate information is C11 and C41.

In block S300, an objective vehicle is determined according to the vehicle identify information and a vehicle location of the objective vehicle is obtained.

In one embodiment, the path planning system marks the vehicle matching with the objective license plate information as the objective vehicle. For example, in block S200, the objective license plate information is C11 and C41. The path planning system marks the first vehicle C1 with the first license plate information C11 as the objective vehicle, and the fourth vehicle C4 with the first license plate information C41 as the objective vehicle.

In one embodiment, the path planning system stores the current location of the vehicle, the road data and the vehicle location of the objective vehicle to a database of the vehicle. The path planning system plans a path of the vehicle based on the data in the database of the vehicle.

In block S400, an objective driving location of the vehicle and a planned driving path of the vehicle are determined based on the vehicle location of the objective vehicle, the current location and the objective driving location of the vehicle.

In some embodiments, the path planning system obtains the objective driving location of the vehicle and plans an initial driving path based on the current location and the objective driving location. The path planning system adjusts the initial driving path in real time to obtain the planned driving path of the vehicle based on the vehicle location matching the objective vehicle. In the embodiment, the path planning system plans the initial driving path from the current location O of the vehicle to the objective driving location. Then, as the vehicle travels, traffic flow status between the current location O and the objective driving location is constantly changing. The path planning system adjusts the initial driving path in real time to obtain the planned driving path of the vehicle based on the vehicle location matching with the objective vehicle. The path planning system can adapt to the changing traffic flow status and plan a path with fewer objective vehicles.

In some embodiments, firstly, the path planning method obtains the road video and the traffic flow video in real time from the current location O to the objective driving location based on the data collection device. Secondly, the path planning method can obtain the road data and the traffic flow data after processing and analyzing the road images and the traffic flow images by the image recognition technology. Then, the path planning method extracts the location of the objective vehicle with the first function from the traffic flow data. The path planning method obtains the objective vehicle with the first function on the road centered on the current location O and radiused by the preset distance. Finally, the planned driving path of the vehicle can be obtained to avoid the road containing more vehicles with the first function, the safety of the driving process is improved.

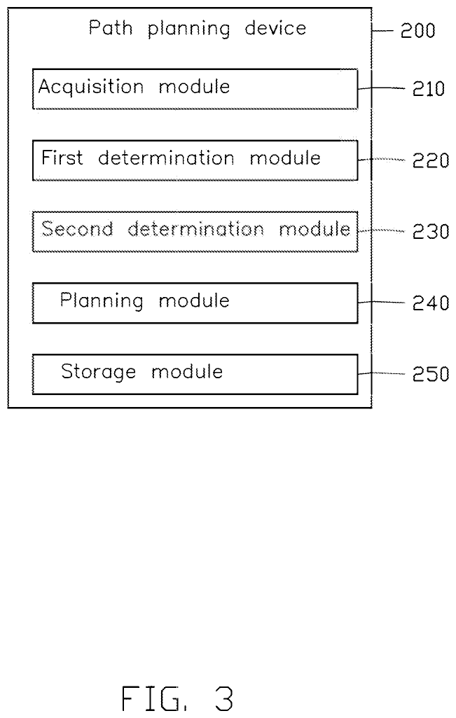

Please refer to FIG. 3, FIG. 3 shows a path planning device 200. The path planning device 200 includes an acquisition module 210, a first determination module 220, a second determination module 230, a planning module 240 and a storage module 250. The acquisition module 210 obtains the current location of the vehicle in real time. The first determination module 220 determines the road data and the traffic flow data matched with the current location of the vehicle, the road data and the traffic flow data are changed with the current location of the vehicle, the road data includes one or more lanes and the lane location corresponding to each lane, and the traffic flow data includes vehicle identify information and vehicle location corresponding to vehicles in each lane. The second determination module 230 determines the objective vehicle according to the vehicle identify information and obtains the vehicle location of the objective vehicle. The planning module 240 obtains the objective driving location of the vehicle and determines the planned driving path of the vehicle based on the vehicle location of the objective vehicle, the current location, and the objective driving location of the vehicle. The storage module 250 stores the current location of the vehicle, the road date and the vehicle location of the objective vehicle to a database of the vehicle.

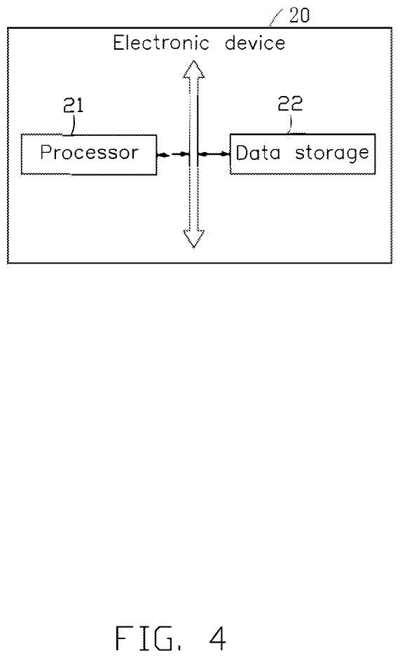

As shown in FIG. 4, one exemplary embodiment of an electronic device 20 comprises at least one processor 21 and a data storage 22. The data storage 22 stores one or more programs which can be executed by the at least one processor 21. The data storage 22 is used to store instructions, and the processor 21 is used to call up instructions from the data storage 22, so that the electronic device 20 performs the steps of the method in the above embodiment. The electronic devices 20 can be desktop computers, laptops, handheld computers, cloud servers and other computing devices. The electronic devices 20 can interact with users through keyboard, mouse, remote control, touchpad or voice control devices.

In one embodiment, a non-transitory storage medium recording instructions is disclosed. When the recorded computer instructions are executed by a processor of an electronic device 20, the electronic device 20 can perform the method.

The embodiments shown and described above are only examples. Many details known in the field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A path planning method applied to a vehicle, the method comprising:
obtaining a current location of the vehicle in real time;
determining road data and traffic flow data matched with the current location of the vehicle, wherein the road data and the traffic flow data are changed with the current location of the vehicle, the road data comprises one or more lanes and a lane location corresponding to each lane, and the traffic flow data comprises vehicle identify information and vehicle locations corresponding to vehicles in each lane;
determining an objective vehicle according to the vehicle identify information and obtaining a vehicle location of the objective vehicle; and
obtaining an objective driving location of the vehicle and determining a planned driving path of the vehicle based on the vehicle location of the objective vehicle, the current location and the objective driving location of the vehicle.

2. The method of claim 1, wherein determining the road data and the traffic flow data matched with the current location of the vehicle comprises:
obtaining the road data and the traffic flow data in a circle centered on the current location of the vehicle and radiused by a preset distance.

3. The method of claim 2, wherein obtaining the road data and the traffic flow data in the circle centered on the current location of the vehicle and radiused by the preset distance comprises:
obtaining environment images in the circle centered on the current location of the vehicle and radiused by the preset distance, wherein the environment images comprise road images and traffic flow images; and
extracting the road data from the road images and extracting the traffic flow data from the traffic flow images.

4. The method of claim 3, wherein extracting the traffic flow data from the traffic flow images comprises:
determining the vehicle identify information matching with the current location of the vehicle based on the traffic flow images, wherein the vehicle identify information comprises first license plate information; and
determining objective license plate information matching with second license plate information from the first license plate information, wherein a vehicle corresponding to the second license plate information comprises a first function, the first function illustrates the vehicle with an automatic driving function, a cargo function, or an engineering function.

5. The method of claim 4, wherein determining the objective vehicle according to the vehicle identify information comprises:
marking a vehicle matching with the objective license plate information as the objective vehicle.

6. The method of claim 1, wherein after obtaining the vehicle location of the objective vehicle, the method further comprises:
storing the current location of the vehicle, the road date and the vehicle location of the objective vehicle to a database of the vehicle.

7. The method of claim 1, wherein determining the planned driving path of the vehicle based on the vehicle location of the objective vehicle, and the current location and the objective driving location of the vehicle comprises:
planning an initial driving path of the vehicle based on the current location and the object driving location of the vehicle; and
adjusting the initial driving path in real time to obtain the planned driving path of the vehicle based on the vehicle location of the objective vehicle.

8. An electronic device, comprising:
at least one processor; and
a data storage storing one or more programs which when executed by the at least one processor, cause the at least one processor to:
obtain a current location of a vehicle in real time;
determine road data and traffic flow data matched with the current location of the vehicle, wherein the road data and the traffic flow data are changed with the current location of the vehicle, the road data comprises one or more lanes and a lane location corresponding to each lane, and the traffic flow data comprises vehicle identify information and vehicle locations corresponding to vehicles in each lane;
determine an objective vehicle according to the vehicle identify information and obtain a vehicle location of the objective vehicle; and
obtain an objective driving location of the vehicle and determining a planned driving path of the vehicle based on the vehicle location of the objective vehicle, the current location and the objective driving location of the vehicle.

9. The electronic device of claim 8, wherein the at least one processor determining the road data and the traffic flow data matched with the current location of the vehicle comprises:
obtaining the road data and the traffic flow data in a circle centered on the current location of the vehicle and radiused by a preset distance.

10. The electronic device of claim 9, wherein the at least one processor obtaining the road data and the traffic flow data in the circle centered on the current location of the vehicle and radiused by the preset distance comprises:
obtaining environment images in the circle centered on the current location of the vehicle and radiused by the preset distance, wherein the environment images comprise road images and traffic flow images; and
extracting the road data from the road images and extracting the traffic flow data from the traffic flow images.

11. The electronic device of claim 10, wherein the at least one processor extracting the traffic flow data from the traffic flow images comprises:
determining the vehicle identify information matching with the current location of the vehicle based on the traffic flow images, wherein the vehicle identify information comprises first license plate information; and
determining objective license plate information matching with second license plate information from the first license plate information, wherein a vehicle corresponding to the second license plate information comprises a first function, the first function illustrates the vehicle with an automatic driving function, a cargo function, or an engineering function.

12. The electronic device of claim 11, wherein the at least one processor determining the objective vehicle according to the vehicle identify information comprises:
marking a vehicle matching with the objective license plate information as the objective vehicle.

13. The electronic device of claim 8, wherein after the at least one processor obtaining the vehicle location of the objective vehicle, the at least one processor is further caused to:
store the current location of the vehicle, the road data and the vehicle location of the objective vehicle to a database of the vehicle.

14. The electronic device of claim 8, wherein the at least one processor determining the planned driving path of the vehicle based on the vehicle location of the objective vehicle, the current location, and the objective driving location of the vehicle comprises:
planning an initial driving path of the vehicle based on the current location and the objective driving location of the vehicle; and
adjusting the initial driving path in real time to obtain the planned driving path of the vehicle based on the vehicle location of the objective vehicle.

15. A non-transitory storage medium having stored thereon instructions that, when executed by a processor of an electronic device, causes the electronic device to perform a path planning method, the path planning method comprising:
obtaining a current location of a vehicle in real time;
determining road data and traffic flow data matched with the current location of the vehicle, wherein the road data and the traffic flow data are changed with the current location of the vehicle, the road data comprises one or more lanes and a lane location corresponding to each lane, and the traffic flow data comprises vehicle identify information and vehicle locations corresponding to vehicles in each lane;
determining an objective vehicle according to the vehicle identify information and obtaining a vehicle location of the objective vehicle; and
obtaining an objective driving location of the vehicle and determining a planned driving path of the vehicle based on the vehicle location of the objective vehicle, the current location, and the objective driving location of the vehicle.

16. The non-transitory storage medium of claim 15, wherein determining the road data and the traffic flow data matched with the current location of the vehicle comprises:
obtaining the road data and the traffic flow data in a circle centered on the current location of the vehicle and radiused by a preset distance.

17. The non-transitory storage medium of claim 16, wherein obtaining the road data and the traffic flow data in the circle centered on the current location of the vehicle and radiused by the preset distance comprises:
obtaining environment images in the circle centered on the current location of the vehicle and radiused by the preset distance, wherein the environment images comprise road images and traffic flow images; and
extracting the road data from the road images and extracting the traffic flow data from the traffic flow images.

18. The non-transitory storage medium of claim 17, wherein extracting the traffic flow data from the traffic flow images comprises:
determining the vehicle identify information matching with the current location of the vehicle based on the traffic flow images, wherein the vehicle identify information comprises first license plate information; and
determining objective license plate information matching with second license plate information from the first license plate information, wherein a vehicle corresponding to the second license plate information comprises a first function, the first function illustrates the vehicle with an automatic driving function, a cargo function or an engineering function.

19. The non-transitory storage medium of claim 18, wherein determining the objective vehicle according to the vehicle identify information comprises:
marking a vehicle matching with the objective license plate information as the objective vehicle.

20. The non-transitory storage medium of claim 15, wherein after obtaining the vehicle location of the objective vehicle, the path planning method further comprises:
storing the current location of the vehicle, the road data and the vehicle location of the objective vehicle to a database of the vehicle.
